(19) United States
(12) Patent Application Publication
(10) Pub. No.: US 2024/0077119 A1
(43) Pub. Date: Mar. 7, 2024

(54) ROTATION SPEED REDUCTION MECHANISM

(71) Applicant: FANUC CORPORATION, Minamitsuru-gun, Yamanashi FANUC CORPORA (JP)

(72) Inventors: Makito NAKAMURA, Minamitsuru-gun, Yamanashi (JP); Masajiro MUROTA, Minamitsuru-gun, Yamanashi (JP)

(73) Assignee: FANUC CORPORATION, Minamitsuru-gun, Yamanashi (JP)

(21) Appl. No.: 18/272,726

(22) PCT Filed: Jul. 17, 2022
(86) PCT No.: PCT/JP2022/001422

§ 371 Date: Jul. 17, 2023

(30) Foreign Application Priority Data
Jan. 26, 2021 (JP) 2021-010141

(51) Int. Cl. F16D 49/00

(52) U.S. Cl. CPC F16D 49/00; F16D 2121/02

(57) ABSTRACT

A rotation speed reduction mechanism according to one embodiment comprises: a fluid passage which allows a pressurized fluid to pass therethrough and is provided such that the pressurized fluid flows toward a shaft; and an elastic member which elastically deforms and comes into contact with the shaft due to the pressurized fluid flowing out from the fluid passage, said elastic member having the base side thereof affixed to a housing, and having a section which extends in an orthogonal direction orthogonal to the direction in which the shaft extends.

### TECHNICAL FIELD

The present invention relates to a rotation speed reduction mechanism of a rotation device having a static pressure bearing.

### BACKGROUND ART

The static pressure bearing rotatably supports a shaft by using a static pressure generated in a fluid film. The fluid film is formed by causing a fluid to flow into a gap between a housing and the shaft inserted into a through hole of the housing. JP 2020-168699 A discloses a machine tool equipped with a rotation device having a static pressure bearing.

### SUMMARY OF THE INVENTION

However, as described in JP 2020-168699 A, in the rotation device having the static pressure bearing, the shaft is in a floating state due to a fluid film formed in a gap between the shaft and the housing. Thus, there is no physical mechanism to slow down the rotation of the shaft. For this reason, there is a case where the rotation speed of the shaft cannot be appropriately reduced only by adjusting the amount of compressed gas guided to the through hole of the housing.

It is therefore an object of the present invention to provide a rotation speed reduction mechanism capable of appropriately reducing the rotation speed of a shaft even when a static pressure bearing is used.

According to an aspect of the present invention, there is provided a rotation speed reduction mechanism of a rotation device, the rotation device including a shaft, a housing including a through hole into which the shaft is inserted, and a static pressure bearing configured to rotatably support the shaft, the rotation speed reduction mechanism including: a fluid passage through which a pressurized fluid flows and which is provided to allow the pressurized fluid to flow toward the shaft; and an elastic member including a proximal end side fixed to the housing and also including a portion extending in an intersecting direction intersecting a direction in which the shaft extends, wherein the elastic member is elastically deformed by the pressurized fluid flowing out from the fluid passage, to come into contact with the shaft.

According to the aspect of the present invention, rotation of the shaft can be braked by contact of the elastic member with the shaft, and in addition, the braking amount can be adjusted according to the degree of pressurization of the pressurized fluid. Therefore, it is possible to appropriately reduce the rotation speed of the shaft even when the static pressure bearing is used.

### BRIEF DESCRIPTION OF DRAWINGS

FIG. 1 is a schematic cross-sectional view showing a rotation device according to one embodiment;

FIG. 2 is a cross-sectional view taken along line II-II;

FIG. 3 is a diagram illustrating a state in which an elastic member is in contact with a shaft;

FIG. 4 is a diagram illustrating a rotation speed reduction mechanism according to a first modification;

FIG. 5 is a diagram illustrating a rotation speed reduction mechanism according to a second modification;

FIG. 6 is a diagram illustrating a rotation speed reduction mechanism according to a third modification;

FIG. 7 is a diagram illustrating a rotation speed reduction mechanism according to a fourth modification; and

FIG. 8 is a view showing a rotation speed reduction mechanism not equipped with a housing piece.

### DETAILED DESCRIPTION OF THE INVENTION

### Embodiment

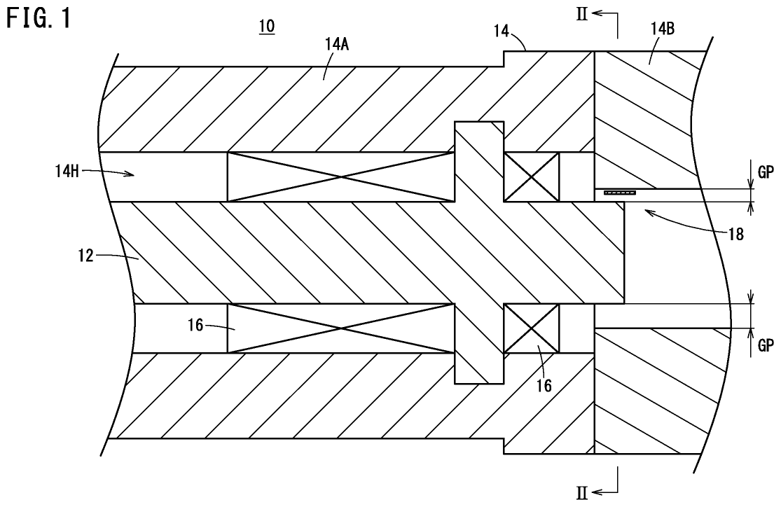

FIG. 1 is a schematic cross-sectional view illustrating a rotation device 10 according to one embodiment. The rotation device 10 is mounted on a machine tool or the like. The machine tool is, for example, a machining center or a lathe machine. The rotation device 10 includes a shaft 12, a housing 14, a static pressure bearing 16, and a rotation speed reduction mechanism 18.

The shaft 12 is rotated by power transmitted from a power source. The power source may be a motor or a compressor. When the power source is a motor, the shaft 12 rotates in conjunction with the rotation of the motor via a power transmission mechanism such as a gear or a joint. When the power source is a compressor, the shaft 12 rotates in conjunction with a fluid supplied from the compressor via a power transmission mechanism such as a turbine. The fluid may be pressurized. Specific examples of the fluid include air, nitrogen, or a mixture thereof.

When the rotation device 10 is mounted on a machining center, a tool or a tool holder is attached to one end portion of the shaft 12 opposite to the other end portion of the shaft 12 on which the rotation speed reduction mechanism 18 is disposed. When the rotation device 10 is mounted on a lathe machine, a table on which a workpiece is to be fixed is attached to one end portion of the shaft 12 opposite to the other end portion of the shaft 12 on which the rotation speed reduction mechanism 18 is disposed.

The housing 14 has a through hole 14H through which the shaft 12 is inserted. The housing 14 may be integrally formed, or may be formed by joining a plurality of separated housing pieces 14A and 14B with bolts or the like. The housing 14 shown in FIG. 1 is formed by joining an attached housing piece 14B to a housing piece 14A. The housing piece 14A is provided with a static pressure bearing 16, and the housing piece 14B is provided with a rotation speed reduction mechanism 18.

The static pressure bearing 16 is configured to be capable of forming a fluid film. The fluid film is formed in a gap GP between the housing 14 and the shaft 12 inserted into the through hole 14H of the housing 14 by sending, into the gap GP, a fluid supplied from the outside. The static pressure bearing 16 rotatably supports the shaft 12 by using a static pressure generated in the fluid film. The fluid may be pressurized. The fluid may be, for example, air, nitrogen, or a mixture thereof.

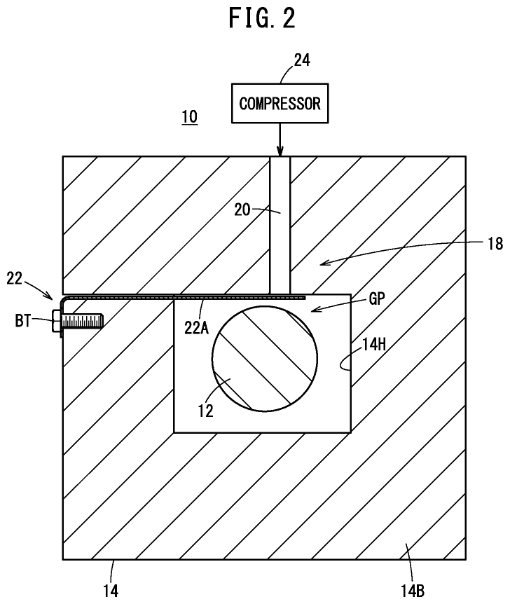

The rotation speed reduction mechanism 18 is a mechanism that reduces the rotation speed of the shaft 12. FIG. 2 is a cross-sectional view taken along line II-II. The rotation speed reduction mechanism 18 includes a fluid passage 20 and an elastic member 22.

The fluid passage 20 is a passage through which a pressurized fluid flows. The fluid passage 20 is provided to allow a pressurized fluid to flow toward the shaft 12. The fluid passage 20 is formed in the housing 14 in this embodiment. The fluid passage 20 allows pressurized fluid to blow on a surface of the elastic member 22 that faces the inner peripheral surface of the housing 14. An output-side opening of the fluid passage 20 faces the elastic member 22, and an input-side opening of the fluid passage 20 is connected to the compressor 24.

The compressor 24 adjusts the degree of pressurization of the fluid and outputs the pressurized fluid to the fluid passage 20. The pressurized fluid supplied to the fluid passage 20 may be the same as or different from the fluid supplied to the static pressure bearing 16. When the pressurized fluid supplied to the fluid passage 20 and the fluid supplied to the static pressure bearing 16 are the same, the compressor 24 may output the pressurized fluid to both the fluid passage 20 and the static pressure bearing 16. The compressor 24 may also be the power source for rotating the shaft 12. When the compressor 24 is the power source for rotating the shaft 12, the compressor 24 outputs pressurized fluid to both the fluid passage 20 and a power transmission mechanism such as a turbine. In this case, the compressor 24 may also output the pressurized fluid to the static pressure bearing 16.

The elastic member 22 brakes the rotation of the shaft 12 by the pressurized fluid flowing out of the fluid passage 20. The proximal end side of the elastic member 22 is fixed to the housing 14, and the open end of the elastic member 22 is disposed in the gap GP between the shaft 12 and the housing 14. In this embodiment, the elastic member 22 is fixed to the outer surface of the housing 14 with a fastener such as a bolt BT. Furthermore, the elastic member 22 penetrates the housing 14 from the outer surface of the housing 14 to the inner peripheral surface of the housing 14. Furthermore, the elastic member 22 extends from the inner peripheral surface of the housing 14 to the gap GP between the shaft 12 and the housing 14.

The elastic member 22 has a portion 22A (hereinafter referred to as a main body portion 22A) extending in an intersecting direction which intersects a direction in which the shaft 12 extends. The main body portion 22A is disposed in the gap GP between the shaft 12 and the housing 14. Portions of the elastic member 22 other than the main body portion 22A may or may not extend in the intersecting direction. Preferably, the intersecting direction is orthogonal to the direction in which the shaft 12 extends (see FIG. 2).

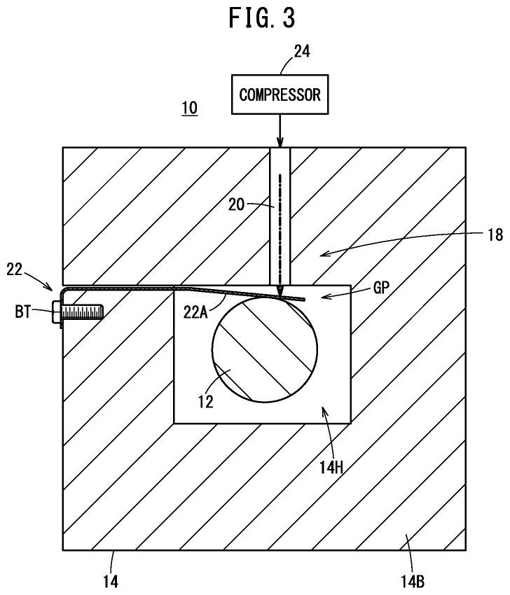

FIG. 3 is a view showing a state in which the elastic member 22 is in contact with the shaft 12. The elastic member 22 is formed into a plate shape. The pressurized fluid flowing out from the fluid passage 20 into the gap GP is caused to blow on the elastic member 22 having a plate shape. The surface of the elastic member 22 on which the pressurized fluid blows is a surface facing the inner peripheral surface of the housing 14. The elastic member 22 is elastically deformed by the blowing pressurized fluid and comes into contact with the shaft 12. As a result, the rotation of the shaft 12 can be braked by the contact of the elastic member 22 with the shaft 12, and the braking amount can be adjusted according to the degree of pressurization of the pressurized fluid. Therefore, even when the static pressure bearing 16 is used, the rotation speed of the shaft 12 can be appropriately reduced.

### [Modifications]

The above embodiment may be modified as follows.

### (Modification 1)

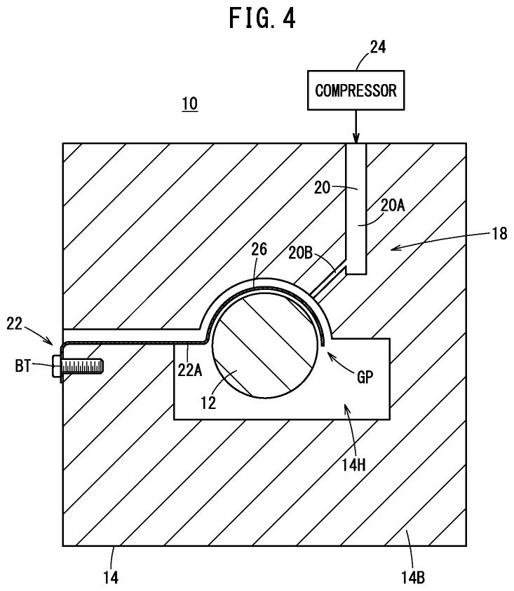

FIG. 4 is a diagram illustrating a rotation speed reduction mechanism 18 according to a first modification. In FIG. 4, the same reference numerals are used to designate constituent elements that are the same as those described in the embodiment. Moreover, in the present modification, descriptions that overlap or are duplicative of those stated in the embodiment will be omitted.

The elastic member 22 of the present modification has a circular arc portion 26 disposed along the outer periphery of the shaft 12. The circular arc portion 26 is formed on the main body portion 22A. As a result, the contact area of the elastic member 22 in contact with the shaft 12 is increased and the frictional force can be accordingly increased, as compared with the case where the circular arc portion 26 is not provided. As a result, the braking force against the rotation of the shaft 12 can be increased.

In FIG. 4, the shape of the through hole 14H formed in the housing piece 14B is different from the shape of the embodiment, but may be the same as or similar in geometry to the shape of the embodiment.

### (Modification 2)

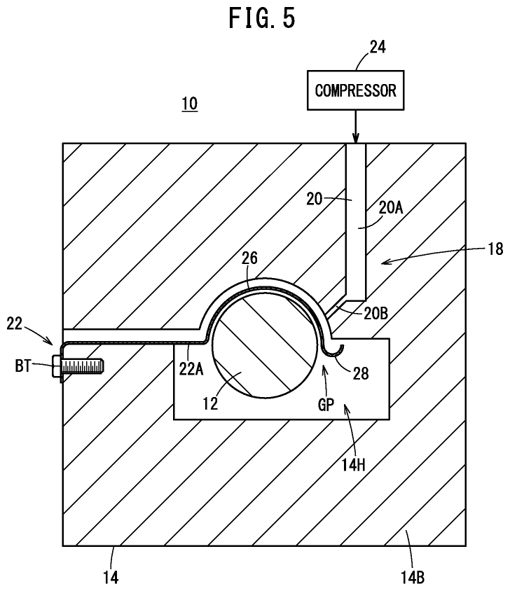

FIG. 5 is a diagram illustrating a rotation speed reduction mechanism 18 according to a second modification. In FIG. 5, the same reference numerals are used to designate constituent elements that are the same as those described in the embodiment. Moreover, in the present modification, descriptions that overlap or are duplicative of those stated in the embodiment will be omitted.

The fluid passage 20 of the present modification includes a first fluid passage 20A and a second fluid passage 20B as in the first modification. The first fluid passage 20A includes an input opening through which fluid is inputted. The second fluid passage 20B is connected to the first fluid passage 20A, is narrower than the first fluid passage 20A, and includes an outlet opening through which fluid is outputted. That is, in the fluid passage 20 according to the first modification and the second modification, the output side of the fluid passage 20 is narrowed. Owing to this configuration, the outflow pressure of the pressurized fluid can be increased, compared to the case of the embodiment in which the cross-sectional area of the fluid passage 20 is substantially constant from the input opening to the output opening. As a result, the contact pressure of the elastic member 22 that acts on the shaft 12 when the elastic member is elastically deformed by the pressurized fluid and comes into contact with the shaft 12, can be increased.

Furthermore, in the fluid passage 20 of the present modification, the output opening is formed such that the pressurized fluid flows from the proximal end side toward the distal end side of the elastic member 22. This makes it easy to bring the distal end side of the elastic member into contact with the shaft 12 due to elastic deformation of the elastic member 22. As a result, the contact pressure of the elastic member 22 can be increased.

The elastic member 22 of the present modification further includes a fluid receiving portion 28 in addition to the circular arc portion 26. The fluid receiving portion 28 is a portion that receives the pressurized fluid so as to increase the contact pressure with the shaft 12. Since the elastic member 22 includes the fluid receiving portion 28, the contact pressure acting on the shaft 12 per unit amount of the pressurized fluid can be increased as compared with a case where the elastic member 22 does not include the fluid receiving portion 28. As a result, the braking force against the rotation of the shaft 12 can be increased.

The fluid receiving portion 28 is provided so as to receive the pressurized fluid flowing from the proximal end side to the distal end side of the elastic member 22 (see FIG. 5). This makes it easy to bring the distal end side of the elastic member into contact with the shaft 12 due to elastic deformation of the elastic member 22. As a result, the contact pressure of the elastic member 22 can be increased.

In addition, the fluid receiving portion 28 is formed by the distal end of the elastic member 22 being turned up toward the inner peripheral surface of the housing 14 (housing piece 14B) (see FIG. 5). Thus, the fluid receiving portion 28 can be provided in the elastic member 22 without using a fastener or the like. In addition, the contact pressure acting on the shaft 12 per unit amount of the pressurized fluid can be increased more easily than in the case where the fluid receiving portion 28 is formed at a location other than the distal end of the elastic member 22.

In FIG. 5, the shape of the through hole 14H formed in the housing piece 14B is different from the shape of the embodiment, but may be the same as or similar in geometry to the shape of the embodiment.

### (Modification 3)

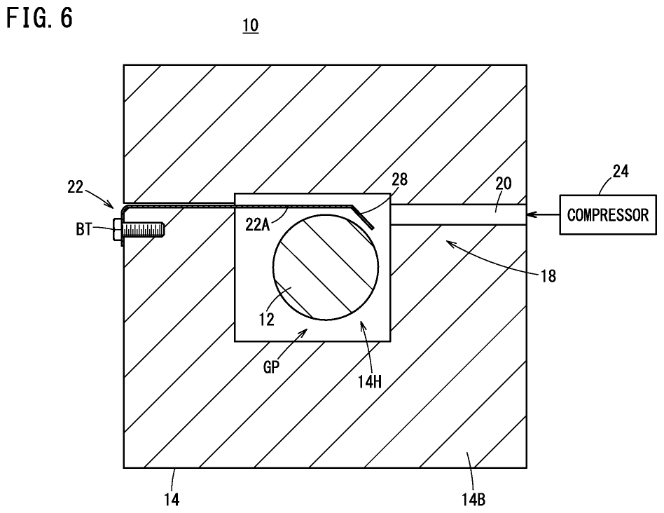

FIG. 6 is a diagram illustrating a rotation speed reduction mechanism 18 of a third modification. In FIG. 6, the same reference numerals are used to designate constituent elements that are the same as those described in the embodiment. Moreover, in the present modification, descriptions that overlap or are duplicative of those stated in the embodiment will be omitted.

The fluid passage 20 of the present modification is formed in the housing 14 along the direction in which the main body portion 22A of the elastic member 22 extends. Furthermore, the elastic member 22 of the present modified example has a fluid receiving portion 28. As a result, the contact pressure acting on the shaft 12 per unit amount of the pressurized fluid can be increased as compared with a case where the fluid receiving portion 28 is not provided. As a result, the braking force against the rotation of the shaft 12 can be increased.

The fluid receiving portion 28 of the present modification is formed by bending the distal end of the elastic member 22 toward the shaft 12. Thus, the fluid receiving portion 28 can be provided in the elastic member 22 without using a fastener or the like. In addition, the contact pressure acting on the shaft 12 per unit amount of the pressurized fluid can be increased more easily than in the case where the fluid receiving portion 28 is formed at a location other than the distal end of the elastic member 22.

### (Modification 4)

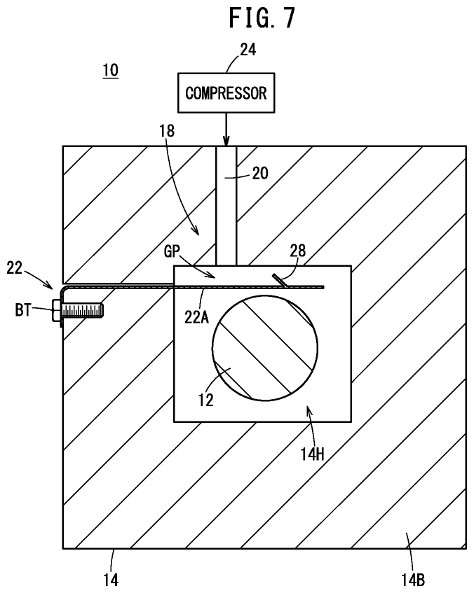

FIG. 7 is a diagram illustrating a rotation speed reduction mechanism 18 according to a fourth modification. In FIG. 7, the same reference numerals are used to designate constituent elements that are the same as those described in the embodiment. Moreover, in the present modification, descriptions that overlap or are duplicative of those stated in the embodiment will be omitted.

The elastic member 22 of the present modification has a fluid receiving portion 28. As a result, the contact pressure acting on the shaft 12 per unit amount of the pressurized fluid can be increased as compared with a case where the fluid receiving portion 28 is not provided. As a result, the braking force against the rotation of the shaft 12 can be increased.

The fluid receiving portion 28 of the present modification is disposed closer to the distal end side of the elastic member 22 than the output opening of the fluid passage 20. Further, the fluid receiving portion 28 extends toward the outlet opening of the fluid passage 20 so as to form an acute angle with the surface of the main body portion 22A of the elastic member 22. Thus, the fluid receiving portion 28 can receive the pressurized fluid flowing from the proximal end side to the distal end side of the elastic member 22. Therefore, it is possible to easily bring the distal end side of the elastic member 22 into contact with the shaft 12 due to the elastic deformation of the elastic member 22. As a result, the contact pressure of the elastic member 22 can be increased.

### (Modification 5)

In the elastic member 22, a portion other than the main body portion 22A may be formed into a shape different from the plate shape, and only the main body portion 22A may be formed into the plate shape. Even in this case, similarly to the embodiment, the elastic member 22 can be elastically deformed by the pressurized fluid flowing in the gap GP between the shaft 12 and the housing 14, to thereby come into contact with the shaft 12.

Note that the shape of the main body portion 22A is not limited to a plate shape as long as the main body portion 22A can be elastically deformed by the pressurized fluid flowing out from the fluid passage 20 to thereby come into contact with the shaft 12.

### (Modification 6)

A portion of the main body portion 22A opposite from the distal end of the main body portion 22A may be fixed to the inner surface (inner peripheral surface) of the housing 14. In this case, since a portion other than the main body portion 22A does not need to be provided, the elastic member 22 can be made smaller than the elastic member 22 of the embodiment. In addition, similarly to the embodiment, the elastic member 22 can be elastically deformed by the pressurized fluid flowing in the gap GP between the shaft 12 and the housing 14 to come into contact with the shaft 12.

### (Modification 7)

The elastic member 22 may have electric conductivity and be connected to the ground. When the housing 14 has electric conductivity, the elastic member 22 may be connected to the ground via the housing 14. When the elastic member 22 is connected to the ground, the shaft 12 is electrically connected to the ground via the elastic member 22. Thus, static electricity generated in the shaft 12 can be removed, and as a result, accidents, troubles, or the like caused by the static electricity accumulated in the shaft 12 can be prevented.

### (Modification 8)

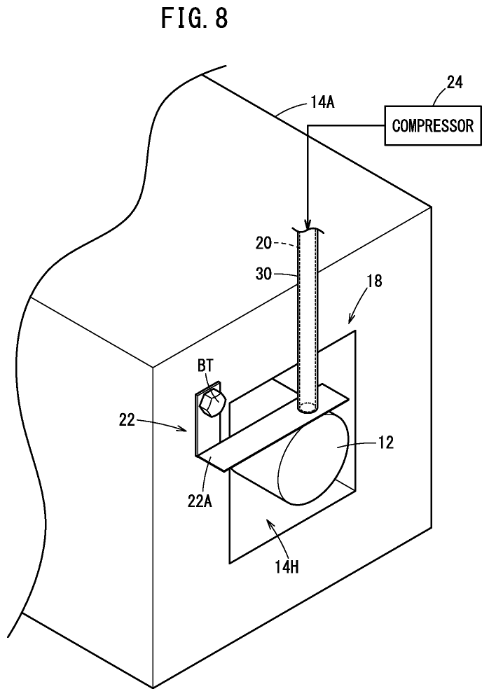

FIG. 8 is a view showing the rotation speed reduction mechanism 18 in the case where the housing piece 14B is not provided. In FIG. 8, the same reference numerals are used to designate constituent elements that are the same as those described in the embodiment. Moreover, in the present modification, descriptions that overlap or are duplicative of those stated in the embodiment will be omitted.

In this modification, the housing piece 14B, which is provided with the rotation speed reduction mechanism 18 in the embodiment, is not provided. Since the housing piece 14B is not provided, the end portion of the shaft 12 close to the rotation speed reduction mechanism 18 is exposed.

Further, in the present modification, a pipe 30 for flowing the pressurized fluid toward the shaft 12 is newly provided. The pipe 30 may be fixed to the housing piece 14A that serves as the main body, or may be fixed to a member other than the housing piece 14A. The outlet opening of the pipe 30 faces the surface of the plate-shaped main body portion 22A of the elastic member 22 with a gap between the outlet opening and the surface of the main body portion 22A, and the inlet opening of the pipe 30 is connected to the compressor 24. The pressurized fluid is supplied from the compressor 24 into the inside of the pipe 30. In other words, the fluid passage 20 is the inside of the pipe 30.

The proximal end side of the elastic member 22 of the present modification is fixed to an end surface of the main body housing piece 14A that is positioned on a side where the rotation speed reduction mechanism 18 is disposed. The main body portion 22A of the elastic member 22 is disposed so as to pass above the shaft 12 with a gap between the main body portion 22A and the shaft 12.

The pressurized fluid flowing out from the pipe 30 is caused to blow on the surface of the main body portion 22A formed in a plate shape. The elastic member 22 is elastically deformed by the pressurized fluid and comes into contact with the shaft 12. As a result, as in the embodiment, the rotation of the shaft 12 can be braked by the contact of the elastic member 22 with the shaft 12, and, in addition, the braking amount can be adjusted according to the degree of pressurization of the pressurized fluid. Therefore, even when the static pressure bearing 16 is used, the rotation speed of the shaft 12 can be appropriately reduced.

### (Modification 9)

The above-described embodiment and Modifications 1 to 8 may be optionally combined within a range in which no technical inconsistencies occur.

### [Invention]

The inventions that can be grasped from the above embodiment and Modifications 1 to 8 are described below.

One aspect of the present invention is the rotation speed reduction mechanism (18) of the rotation device (10), the rotation device including the shaft (12), the housing (14) including the through hole (14H) into which the shaft is inserted, and the static pressure bearing (16) configured to rotatably support the shaft, the rotation speed reduction mechanism including: the fluid passage (20) through which the pressurized fluid flows and which is provided to allow the pressurized fluid to flow toward the shaft; and the elastic member (22) including the proximal end side fixed to the housing and also including the portion (22A) extending in the intersecting direction intersecting the direction in which the shaft extends, wherein the elastic member (22) is elastically deformed by the pressurized fluid flowing out from the fluid passage, to come into contact with the shaft.

Thus, the rotation of the shaft can be braked by the contact of the elastic member with the shaft. In addition, the braking amount can be adjusted in accordance with the degree of pressurization of the pressurized fluid. Therefore, it is possible to appropriately reduce the rotation speed of the shaft even when the static pressure bearing is used.

At least the portion of the elastic member may be formed into a plate shape, and the fluid passage may be provided such that the pressurized fluid flowing out from the fluid passage is caused to blow on a surface of the elastic member formed into the plate shape, the surface of the elastic member being opposite to a surface of the elastic member that faces the shaft. With this configuration, it is possible to easily bring the distal end side of the elastic member into contact with the shaft due to the elastic deformation of the elastic member, and the contact pressure of the elastic member can be increased.

The fluid passage may be formed in the housing. Thus, the rotation of the shaft can be braked inside the housing.

The housing may include the main body housing piece (14A) that is provided with the static pressure bearing and the attached housing piece (14B) that is attached to the main body housing piece, and the fluid passage may be formed in the attached housing piece (14B). This makes it easier to dispose the elastic member than in the case where the housing piece serving as the main body and the attached housing piece are integrated as one member.

The rotation speed reduction mechanism may further include the pipe (30) provided so as to allow the pressurized fluid to flow toward the shaft, and the fluid passage may be the inside of the pipe. Thus, the rotation of the shaft can be braked outside the housing.

The elastic member may include the circular arc portion (26) disposed along the outer periphery of the shaft. With this configuration, the contact area of the elastic member in contact with the shaft can be increased and the frictional force can be accordingly increased, as compared with the case where the circular arc portion is not provided. As a result, the braking force against the rotation of the shaft can be increased.

The elastic member may include the fluid receiving portion (28) for receiving the pressurized fluid so as to increase contact pressure of the elastic member with the shaft. With this configuration, it is possible to increase the contact pressure of the shaft per unit amount of the pressurized fluid, compared to a case where the fluid receiving portion is not provided. As a result, it is possible to increase the braking force with respect to the rotation of the shaft.

The fluid receiving portion may receive the pressurized fluid flowing from the proximal end side to the distal end side of the elastic member. With this configuration, it is possible to easily bring the distal end side of the elastic member into contact with the shaft due to the elastic deformation of the elastic member, and the contact pressure of the elastic member can be increased.

The fluid receiving portion may be formed by the distal end of the elastic member being turned up. With this configuration, the fluid receiving portion can be provided in the elastic member without using a fastener or the like. In addition, the contact pressure of the shaft per unit amount of the pressurized fluid can be easily increased as compared with a case where the fluid receiving portion is formed at a position other than the distal end of the elastic member.

The elastic member may be fixed to the outer surface of the housing, penetrate through the housing from the outer surface of the housing to the inner peripheral surface of the housing, and extend in the intersecting direction. With this configuration, the elastic member can be provided without being affected by the distance of the gap between the shaft and the housing or the like, as compared with a case where the elastic member is fixed to the inner surface (inner peripheral surface) of the housing.

The elastic member may have electric conductivity and be connected to the ground. With this configuration, the shaft and the ground can be electrically connected to each other via the elastic member, to thereby remove static electricity generated in the shaft. As a result, it is possible to prevent accidents, troubles, or the like caused by static electricity accumulated in the shaft.

1. A rotation speed reduction mechanism of a rotation device, the rotation device including a shaft, a housing including a through hole into which the shaft is inserted, and a static pressure bearing configured to rotatably support the shaft, the rotation speed reduction mechanism comprising:
a fluid passage through which a pressurized fluid flows and which is provided to allow the pressurized fluid to flow toward the shaft; and
an elastic member including a proximal end side fixed to the housing and also including a portion extending in an intersecting direction intersecting a direction in which the shaft extends, wherein the elastic member is elastically deformed by the pressurized fluid flowing out from the fluid passage, to come into contact with the shaft.

2. The rotation speed reduction mechanism according to claim 1, wherein
at least the portion of the elastic member is formed into a plate shape, and
the fluid passage is provided in a manner so that the pressurized fluid flowing out from the fluid passage is caused to blow on a surface of the elastic member formed into the plate shape, the surface of the elastic member being opposite to a surface of the elastic member that faces the shaft.

3. The rotation speed reduction mechanism according to claim 1, wherein
the fluid passage is formed in the housing.

4. The rotation speed reduction mechanism according to claim 3, wherein
the housing comprises a main body housing piece that is provided with the static pressure bearing and an attached housing piece that is attached to the main body housing piece, and the fluid passage is formed in the attached housing piece.

5. The rotation speed reduction mechanism according to claim 1, further comprising:
a pipe provided to allow the pressurized fluid to flow toward the shaft,
wherein the fluid passage is an inside of the pipe.

6. The rotation speed reduction mechanism according to claim 1, wherein
the elastic member includes a circular arc portion-PO disposed along an outer periphery of the shaft.

7. The rotation speed reduction mechanism according to claim 1, wherein
the elastic member includes a fluid receiving portion configured to receive the pressurized fluid so as to increase a contact pressure of the elastic member with the shaft.

8. The rotation speed reduction mechanism according to claim 7, wherein
the fluid receiving portion receives the pressurized fluid flowing from the proximal end side to a distal end side of the elastic member.

9. The rotation speed reduction mechanism according to claim 7, wherein
the fluid receiving portion is formed by a distal end of the elastic member being turned up.

10. The rotation speed reduction mechanism according to claim 1, wherein
the elastic member is fixed to an outer surface of the housing, penetrates through the housing from the outer surface of the housing to an inner peripheral surface of the housing, and extends in the intersecting direction.

11. The rotation speed reduction mechanism according to claim 1, wherein
the elastic member has electric conductivity and is connected to a ground.
